(19) United States
(12) Patent Application Publication
(10) Pub. No.: US 2007/0038467 A1
(43) Pub. Date: Feb. 15, 2007

(54) Remote loading of a database

(76) Inventors: Jeffrey Honeyager, Rockford, MI (US); G. Robert Preston, Grand Rapids, MI (US); Shabir Khatami, Grand Rapids, MI (US); Thomas J. Orzechowski, Rockford, MI (US)

Correspondence Address: Max W. Garwood;450 N. Jefferson Street, P.O. Box 30, Huntington, IN, 46750, US

(21) Appl. No.: 11/357,700

(22) Filed: Feb. 17, 2006

Related U.S. Application Data
(60) Provisional application No. 60/701,690, filed on Jul. 22, 2005.

(51) Int. Cl. G06Q 99/00; G06Q 40/00

(52) U.S. Cl. 705/1; 705/38

(57) ABSTRACT

A method of loading a real estate database, including the steps of identifying an address of real estate for an associated task; associating a geographical coordinate to the address; conveying the address and a geographical coordinate to a data gathering apparatus; and fulfilling the task. Fulfilling the task includes the substeps of traveling to a location proximate the geographical coordinate; inputting data about the real estate to the data gathering apparatus; and submitting data by way of the data gathering apparatus to the real estate database.

### CROSS-REFERENCE TO RELATED APPLICATIONS

This is a non-provisional patent application based upon U.S. Provisional Patent application, Ser. No. 60/701,690 bearing the title “REMOTE LOADING OF A DATABASE” filed on Jul. 22, 2005.

### BACKGROUND OF THE INVENTION

1. Field of the Invention

The present invention relates to a method of remotely providing data to a database, and, more particularly, a method to remotely load a database related to real estate.

2. Description of the Related Art

In the real estate management area, delinquent loans on property and abandoned property require attention to reduce the losses associated with the neglect of the property. Such losses to property are reduced by the steps of securing a property by way of changing locks, boarding up windows, and removal of debris and certain types of vegetation. A further method of securing property is for the installation of security devices for the remote sensing of an intruder. Lending institutions indirectly contract with providers of such services to protect their interest in the real estate.

Inspectors (which is a term that is used to broadly describe the individuals who inspect and provide property preservation services) also provide verification of occupancy services. A verification of occupancy includes traveling to an assigned address and observing the property for signs of occupancy and perhaps providing photographs that are then forwarded to the lending institution. Preservation aspects of the inspector's job may include changing lock sets, securing doors and windows, and repairing any avenues of ingress or egress to the structure. Often homes are abandoned with a considerable amount of debris and/or hazardous waste contained therein. Inspectors often will gather information and provide a quote to the lending institution for the removal of the debris and proper disposal of any hazardous waste.

A problem in the industry is the verification of the data that the inspectors provide to the lending institutions. A further problem is that the lending institutions are generally isolated by a couple of layers of service providers that subcontract the inspection, preservation, and repair work.

What is needed in the art is a way to efficiently assign tasks to inspectors and to allow for verification of the work completed.

### SUMMARY OF THE INVENTION

The present invention provides a remote database loading feature by way of a remote data gathering apparatus.

The invention comprises, in one form thereof, a method of loading a real estate database including the steps of identifying, associating, conveying, and fulfilling. The step of identifying includes identifying an address of real estate relative to a task. The step of associating includes associating a geographical coordinate to the address. The step of conveying includes conveying the address and the geographical coordinate to a data gathering apparatus. The step of fulfilling includes the substeps of traveling to a location proximate the geographical coordinate, inputting data about the real estate to the data gathering apparatus and submitting data by way of the data gathering apparatus to the real estate database.

An advantage of the present invention is that the data input into the data gathering device is geostamped to provide a location of the generation of the data.

Another advantage of the present invention is that data information can be assigned and gathered by way of a wireless data gathering device.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIGS. 1-10 illustrate portions of an embodiment of the present invention; and

FIG. 11 illustrates a sequence of events of the method of the present invention from an inspector's perspective.

Corresponding reference characters indicate corresponding parts throughout the several views. The exemplifications set out herein illustrate preferred embodiments of the invention, and such exemplifications are not to be construed as limiting the scope of the invention in any manner.

### DETAILED DESCRIPTION OF THE PRESENT INVENTION

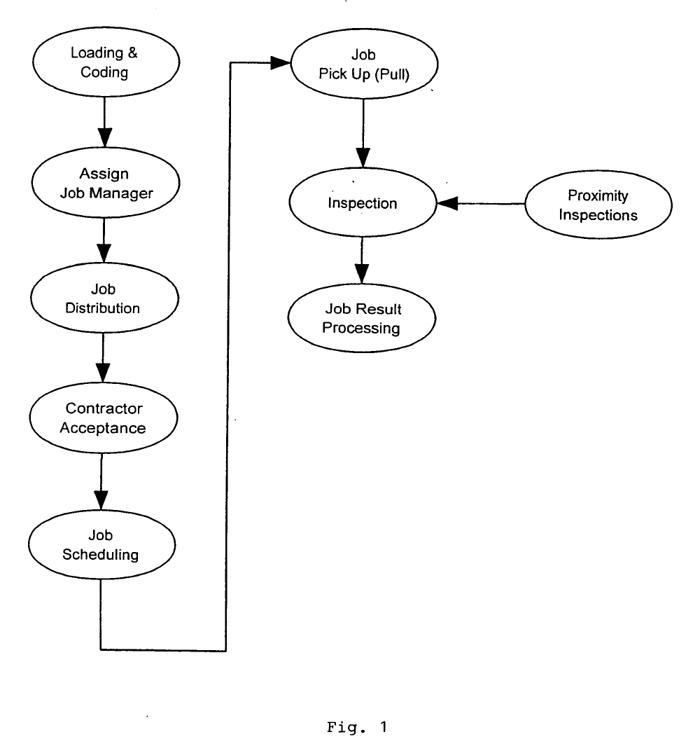

Referring now to the drawings, and, more particularly to FIG. 1, there is shown an overview of a database loading technique including the sub-procedures of loading and coding, assigning a job manager, job distribution, contractor acceptance, job scheduling, job pick-up, proximity inspections, and job result processing. Subsequent figures show additional detail as to the technique of loading a database, particularly a database associated with real estate inspection and preservation.

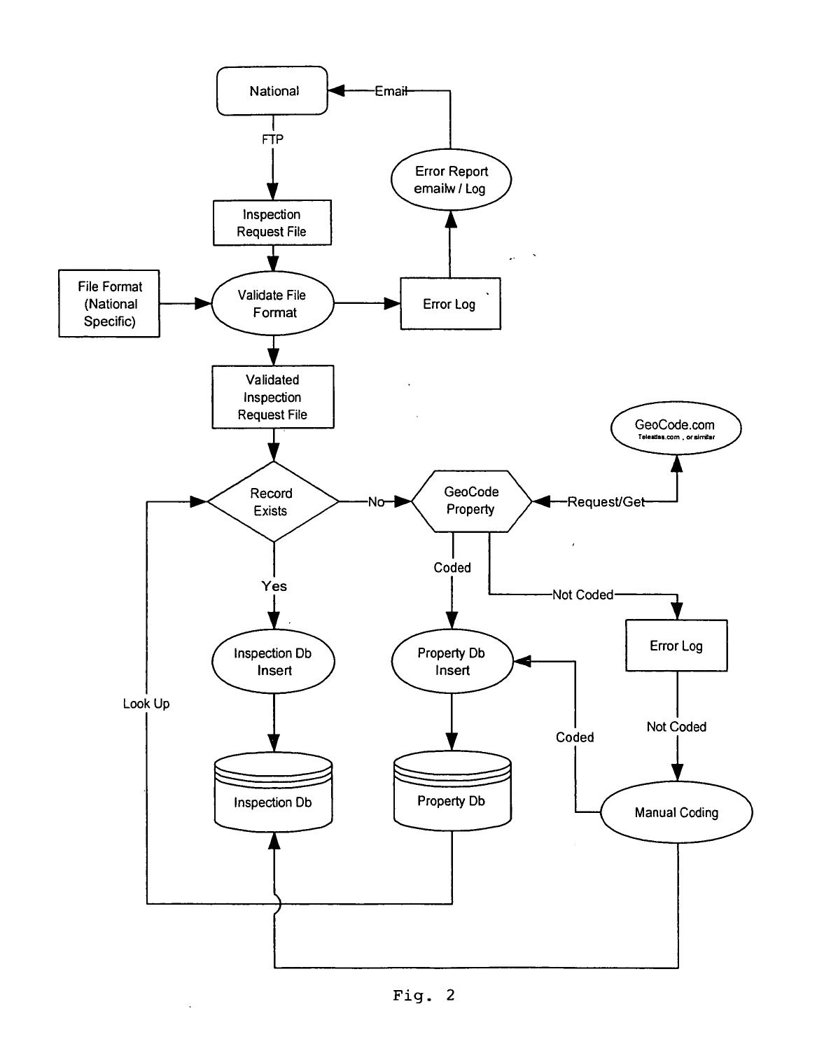

Now, additionally referring to FIG. 2, there is shown the loading and coding subsystem (also known as a sub-procedure) of the method shown in FIG. 1. FIG. 2 illustrates the process of receiving information from a national. A national can be understood as being a supplier of jobs from a financial institution such as a bank. Alternatively, the national may be directly replaced by a requesting entity and the process proceeds from that point. A validated inspection request file is generated and, if a record exists, then information is added to the inspection database. If the record does not exist, a geocode for a property is obtained and, if it is coded, it is inserted into the property database. If no geocode is found, a manual override can be obtained and inserted into the appropriate record.

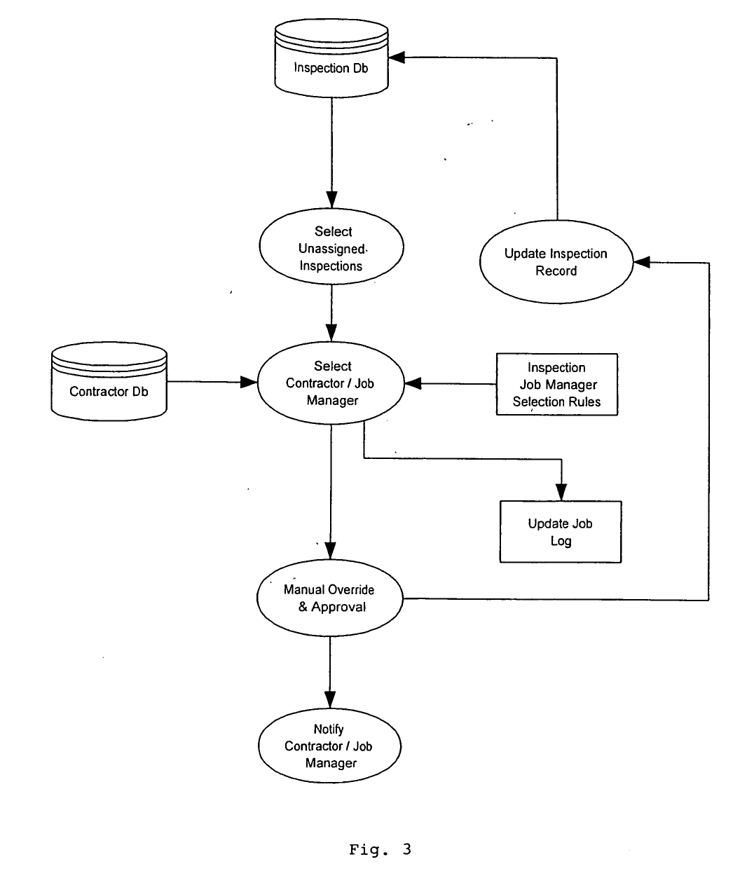

Now, additionally referring to FIG. 3, there is shown an assigned job manager procedure, which is part of method 10 of FIG. 1. This subsystem associates an inspection database with a contractor database to allow a matching of work to contractors. This matching may be associated with the geographical location of the work and the overlapping area covered by contractors; and/or the inspection work may be associated with the expertise of the contractor; and/or the inspection job may be associated with the contractor's prior quality response to previous inspection work; and/or other criteria in which a particular inspection may be associated to a contractor. This information is passed on to the contractor in the form of a notification.

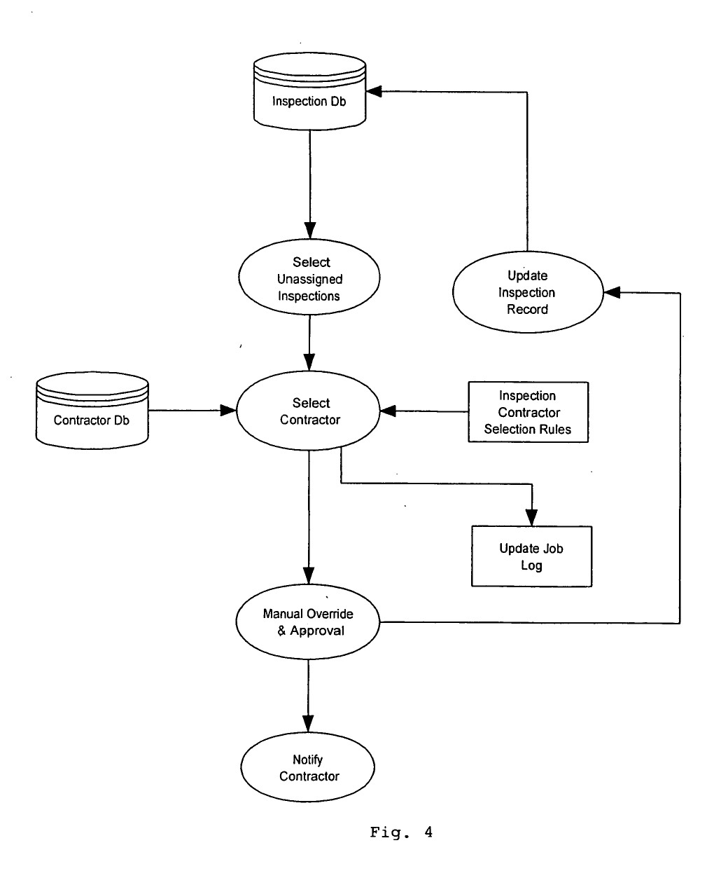

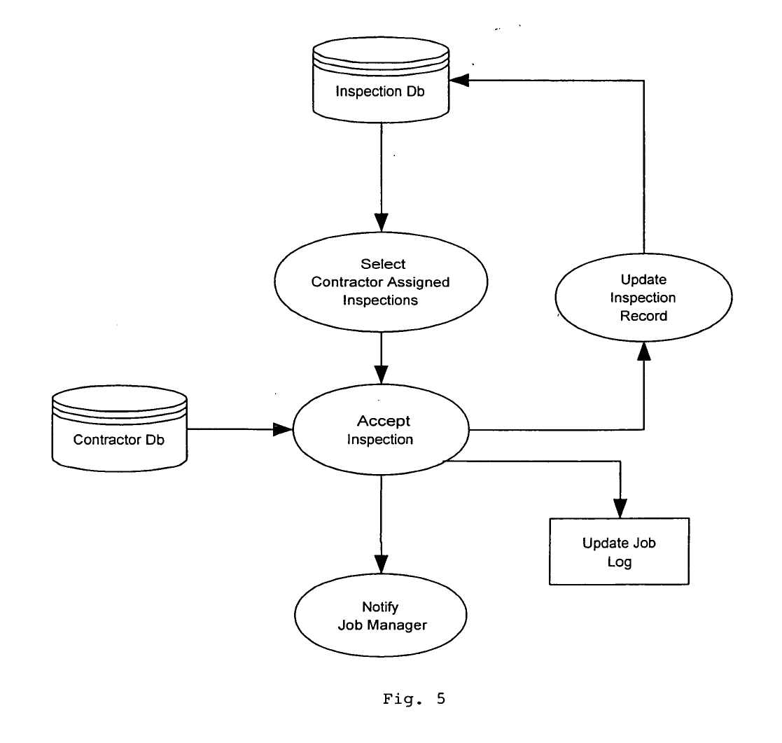

Now, additionally referring to FIGS. 4-5, there is shown a contractor acceptance procedure in which the selected contractor reviews and accepts the assigned work and notifies the job manager.

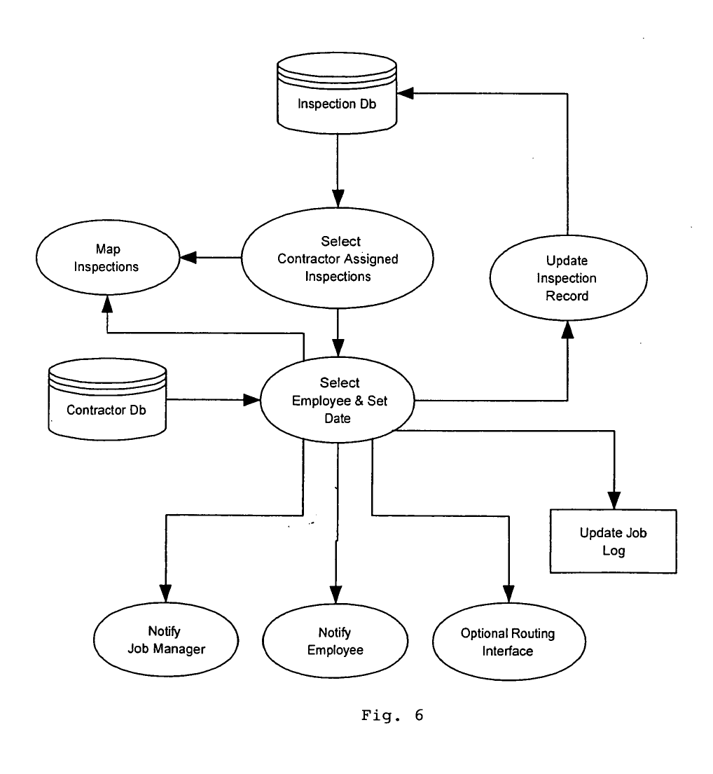

Now, additionally referring to FIG. 6, there is shown a job scheduling subsystem in which the contractor utilizes either an internal system or the system shown in FIG. 6. Inspection is associated with a geographical location and is scheduled by way of an assignment to an employee. The employee is notified of the schedule and associated geographical location. Additionally, the job manager is informed of the assignment of employee as well as the scheduled date for inspection. The employee can be provided a routing to effectively schedule the employee's time and efficiently reduce the amount of travel required for the several inspection points.

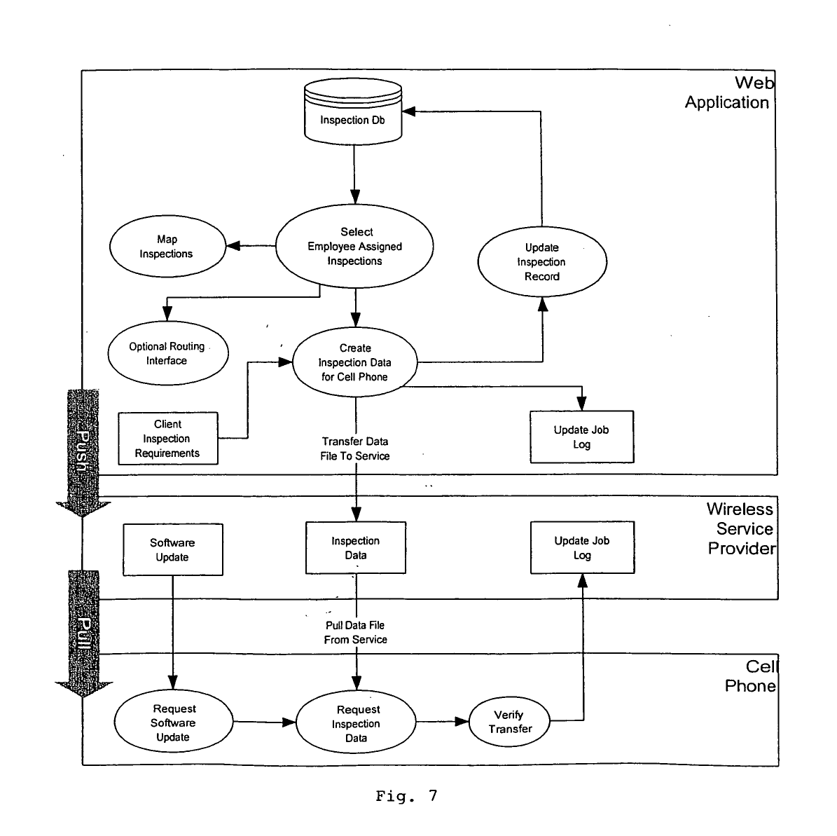

Now, additionally referring to FIG. 7, there is shown a job pickup subsystem of method 10 of FIG. 1. The inspection request information is provided to the employee and downloaded to the employee's cell phone or other data device, which may include the routing information for the various jobs. Each inspection job has a unique identifier associated therewith. The unique identifier is utilized throughout the system to provide the database with a link to which the updated data can be inserted into the database. The information provided to the employee by way of the cellular device includes graphic, pictorial, audio, and/or text information.

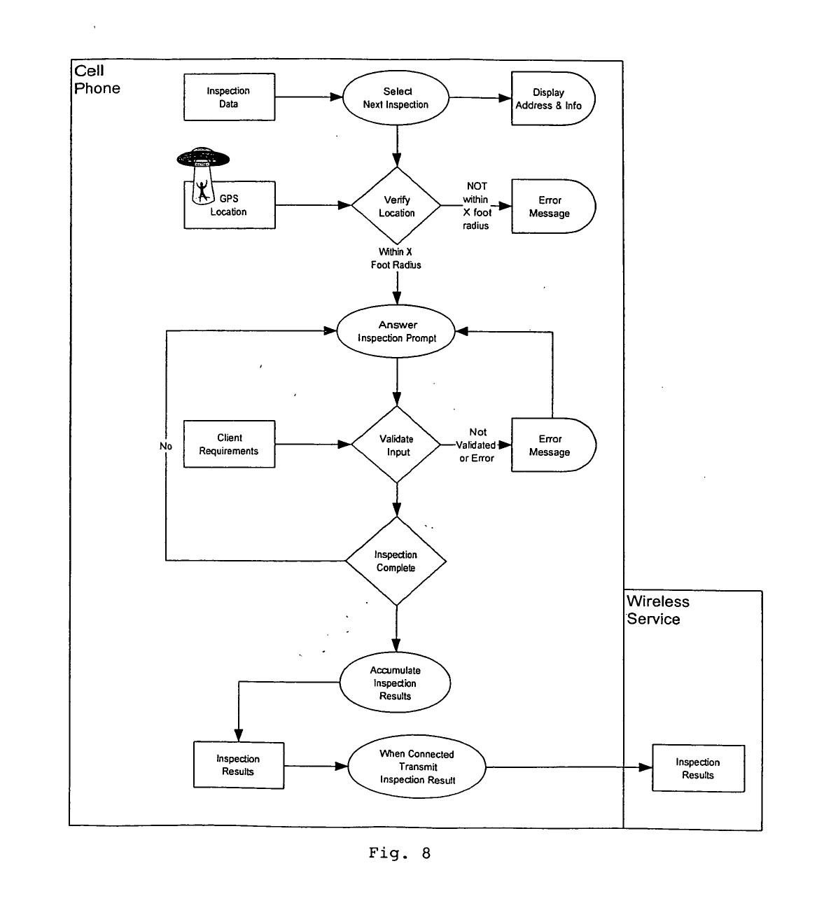

Now, additionally referring to FIG. 8, there is shown an inspection subsystem in which an employee selects the next inspection and the information relative to that inspection point, such as an address and other useful information is displayed. Once the employee is at the location, the location is verified by a GPS interface to provide data as to the location from which inspection information such as photographs is entered. The GPS location is verified to be within a predetermined distance from the geographical location associated with the inspection point. Information that is requested from the request originator is provided on a display portion of the wireless device, requiring the inspector to answer questions as to the real estate condition. The answers may be in subjective, objective, or numeric formats. If the answer given is not a valid answer, the question is re-prompted to the employee. The inspection result, which may include answers to questions as well as photographic and audio information, is associated with the job identifier. Flexibility as to the number of photographs or other data may be in a free field type format, allowing the employee to provide additional information when the employee determines such information may be useful to the requestor. Additionally, the information gathered can be utilized by the contractor to evaluate the effectiveness of the employee in an automated manner. Further, the information collected may be utilized by managers at a higher level to determine the effectiveness of the employee and the contractor. Such data can be utilized in the assignment of future jobs by method 10.

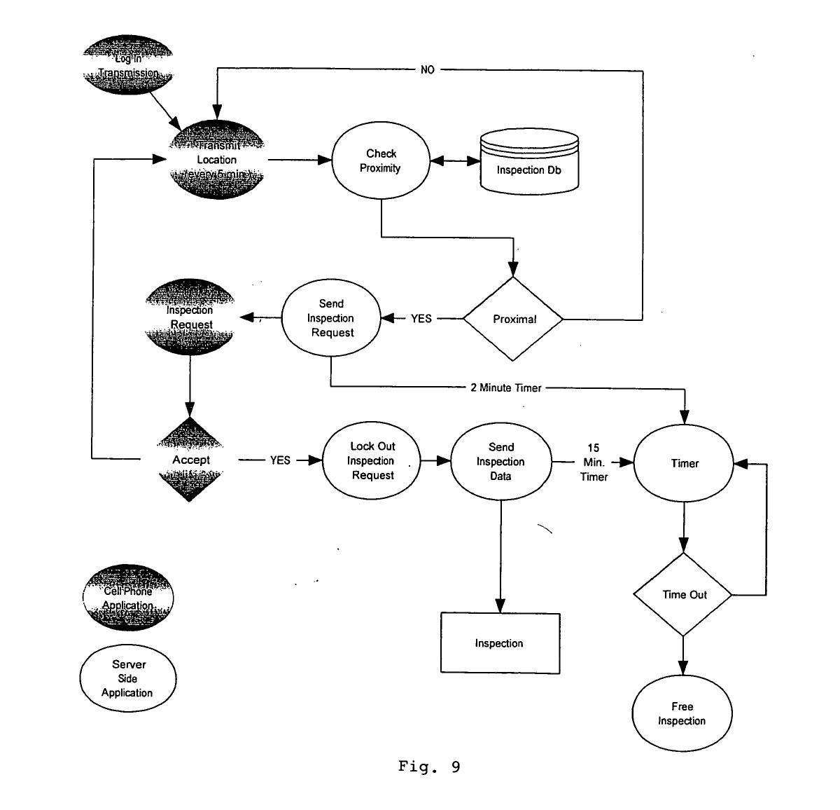

Now, additionally referring to FIG. 9, there is shown a proximity inspection subsystem, which is a part of method 10 of FIG. 1. Continuous feedback of the proximity of the inspector to a job may additionally provide the downloading of additional inspection requests that may interact with the information entered while the inspector is proximate to the site. Additionally, the location of the employee may prompt the assignment of another job in the proximal location. This allows the job assignments to be dynamically updated while inspections are ongoing.

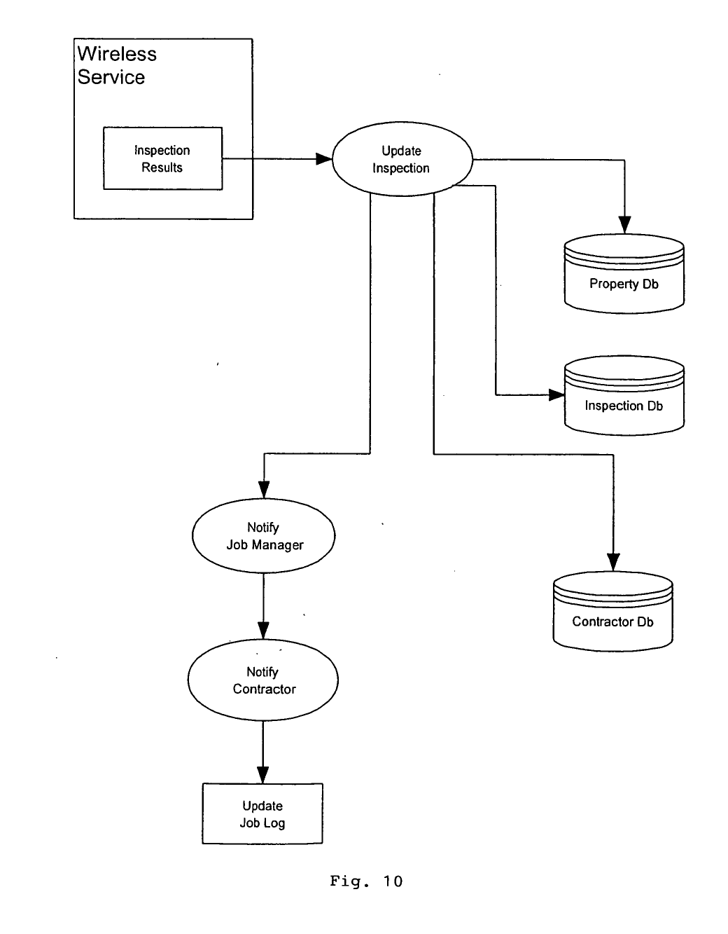

Now, referring to FIG. 10, there is shown a job result processing subsystem, which is a part of method 10 of FIG. 1. What is illustrated in FIG. 10 is that the inspection results are transmitted to update the inspection record, which is inserted into property, inspection, contractor, and any other necessary databases. The inspection information is sent to a job manager, as well as the contractor, and processed information is passed along to the requesting entity identified in FIG. 2. as a national.

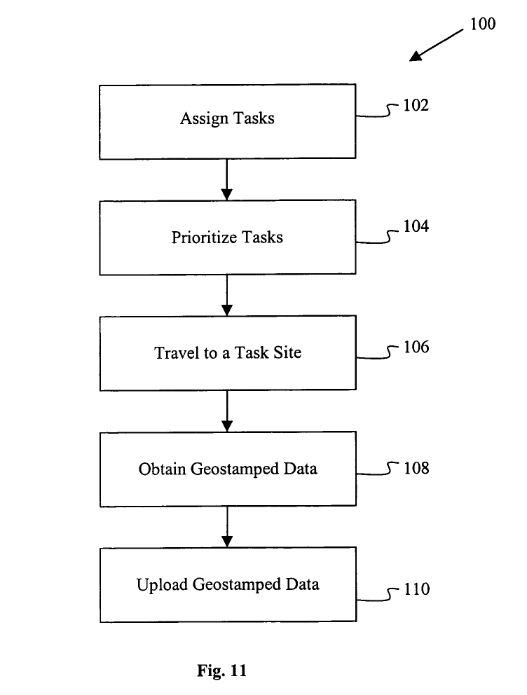

Referring now to FIG. 11, there is illustrated a method 100 that shows a sequence of events that pertain to the inspector as they carry out an inspection or other service at a job site, also known as a distressed property. The present invention makes it possible for an inspector to organize their work lists, collect information, take digital photos, record their observations, and submit the results in a streamlined process. Initially work is assigned at step 102, and made available on their data gathering apparatus, which may be a PDA or cellular phone. The work lists are prioritized at step 104 and are organized and provide a description of which properties to proceed to and the work required at each property. The inspector travels to a work site at step 106, based on the sequence of work sites prioritized at step 104. Information is collected at each work site and, based on the task, data is input, such as photographs of the property. Photographs, as well as any other data input at the property site, are geostamped at step 108, resulting in data that relate to a location and time, which are linked to the data that is being input. Once the task has been completed or the observations made, the data is gathered and the inspector directs the data gathering device to enter the record, which is then transmitted to the real estate database at step 110. The real estate database includes such things as the address of the property, the status of work jobs, priority of the work job, the date the task is to be completed, a property ID, a loan number, the owner's name, the latitude and longitude of the property (which is associated with the geocode), a job ID, the name of the inspector, the type of the inspection, the office name, references to document numbers and clients, the date that the record was added to the system, the date the task was assigned, the date the task was retrieved, the date that the task was rejected, the date that the task was canceled, the date that the task was completed, the reasons for the task being completed, and various instructions to the inspector. The data that is transferred from the inspector back to the real estate database include photographs, which may have connected thereto text and/or audio messages describing the picture. Each picture is geocoded, also known as geostamped, and time-stamped as it is associated with the real estate database. The method additionally correlates the received information with the information from the financial institution, such as the proximity of the latitude and longitude, also known as a geographical coordinate, to the geographical coordinate contained in the data provided from the inspector.

The method provides an automatically prioritized job list for the inspector based upon the date due and the locations, so as to minimize the amount of driving necessary to traverse from one task site to another task site. The system also helps to direct an inspector to the proper location by using the latitude and longitude coordinates of the job along with a GPS receiver connected to the data gathering device or cellular phone. The querying tool on the database server presents results of the textual and graphical information received from the inspector. It uses an integrated map to visually plot the query results on the map in the form of graphic pushpins. Each pushpin icon is displayed on the map at a physical location of the property. The pushpin colors are coded to correspond with the status of the job or the query of the database user. The integrated map is interactive, allowing the user to explore the results by selecting a color-coded pushpin. As the database is populated by the inspector, the pushpin colors are altered to visually show the current status of the assigned task at the particular location.

Additionally, the system can collect information in the form of audio, video, signatures, and environmental measurements. For example, temperature information can be collected at sites, particularly internal to a home, thereby giving information relative to the potential damage to the home. For example, if the temperature measurement inside a home indicates a temperature of 25°, it may be assumed that the plumbing has been damaged in the distressed property.

It is also contemplated that speech-to-text conversion software may be utilized to translate audio comments into textual format, which may be in response to querying provided through the data gathering device. The prompting of the method to an inspector may include audio, text, graphics and images. The prompting may include information from a previous visit to the particular location. For example, the prompt may include a question to ascertain if the lawn has been mowed since the last visit, with a photo from the last visit being displayed for reference purposes. It is to be understood that the database may utilize photographs taken from different angles and times to document damage to the property. Other techniques, such as infrared sensing of the home to determine occupancy, can be used in addition to the visual tools currently utilized.

While this invention has been described with respect to preferred embodiments, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains, and to which the claims are directed.

What is claimed is:

1. A method of loading a real estate database, comprising the steps of:
identifying an address of real estate for a task;
associating a geographical coordinate to said address;
conveying said address and said geographical coordinate to a data gathering apparatus; and
fulfilling said task by the steps of:
traveling to a location proximate said geographical coordinate;
inputting data about said real estate to said data gathering apparatus; and
submitting data by way of said data gathering apparatus to the real estate database.

2. The method of claim 1, wherein said fulfilling step further comprises the step of geostamping said data with an other geographical coordinate that corresponds to a location of said data gathering apparatus when said data is input in said inputting step.

3. The method of claim 2, wherein said other geographical coordinate is one of proximate to and the same as said geographical coordinate.

4. The method of claim 1, wherein said data includes images of said real estate.

5. The method of claim 1, further comprising the step of assigning a plurality of addresses with associated tasks to an inspector.

6. The method of claim 5, further comprising the step of arranging said plurality of addresses so as to minimize the distance the inspector will need to travel to each of said plurality of addresses.

7. A method of loading a real estate database, comprising the steps of:
downloading a data record to a data gathering apparatus, said data record including an address of real estate an associated geographical coordinate and an associated task; and
fulfilling said task by the steps of:
traveling to a location proximate said geographical coordinate;
inputting data about said real estate to said data gathering apparatus; and
submitting data by way of said data gathering apparatus to the real estate database.

8. The method of claim 7 wherein said fulfilling step further comprises the step of geostamping said data with an other geographical coordinate that corresponds to a location said data gathering apparatus was located when said data is input in said inputting step.

9. The method of claim 8, wherein said other geographical coordinate is one of proximate to and the same as said geographical coordinate.

10. The method of claim 7, wherein said data includes images of said real estate.

11. The method of claim 7, further comprising the step of assigning a plurality of addresses with associated tasks to an inspector, prior to said downloading step

12. The method of claim 11, further comprising the step of arranging said plurality of addresses so as to minimize the distance the inspector will need to travel to each of said plurality of addresses.

13. A method of loading a real estate database, comprising the steps of:
receiving an address of real estate and an assigned task relative to said real estate with a data gathering apparatus;
associating a geographical coordinate to said address; and
fulfilling said task by the steps of:
traveling to a location proximate said geographical coordinate;
inputting data about said real estate to said data gathering apparatus; and
submitting data by way of said data gathering apparatus to the real estate database.

14. The method of claim 13, wherein said data gathering apparatus is one of a cell phone and a personal data assistant.

15. The method of claim 13, further comprising the step of prompting an inspector to input data elements associated with said task.

16. The method of claim 15, wherein said prompting step includes using at least one of audio, text and image data to prompt the inspector.

17. The method of claim 16, further comprising the step of recalling previous information relative to the real estate.
